(19) United States
(12) Patent Application Publication
(10) Pub. No.: US 2013/0255359 A1
(43) Pub. Date: Oct. 3, 2013

(54) CONTAINERIZED MOBILE GAS TURBINE FILTER TEST FACILITY

(71) Applicants: Peter John Duncan Smith, Basingstoke (GB); Stephen David Hiner, Wiltshire (GB); Stephen Francis Banks, Hamshire (GB)

(72) Inventors: Peter John Duncan Smith, Basingstoke (GB); Stephen David Hiner, Wiltshire (GB); Stephen Francis Banks, Hamshire (GB)

(73) Assignee: General Electric Company, Schenectady, NY (US)

(21) Appl. No.: 13/433,371

(22) Filed: Mar. 29, 2012

(51) Int. Cl. G01N 15/08

(52) U.S. Cl. 73/38

(57) ABSTRACT

A portable filter testing assembly for testing filter elements is provided. The portable filter testing assembly includes a first modular component including filter elements disposed within an interior and a fluid flow inlet. The testing assembly further includes a second modular component in fluid communication with the first modular component and includes fluid flow drawing means for drawing fluid flow through the filter elements of the first modular component such that the fluid flow is filtered by the filter elements. Each of the first modular component and second modular component includes an external structure of a modular International Organization for Standardization (ISO) shipping container. A kit of plural modular components for testing filter elements is provided. A method of using ISO modular components for testing filter elements is also provided.

### BACKGROUND OF THE INVENTION

1. Field of the Invention

The invention relates to a filter assembly and, more particularly, to a portable filter testing assembly for testing filter elements to be used in a gas turbine inlet.

2. Discussion of Prior Art

Filter elements are typically used in gas turbine inlet systems for filtering entering air flow. Incorporating untested or developmental filter elements (“test filter elements”) in a gas turbine inlet system may be problematic to the inlet system if the test filter elements do not perform up to expectations by not filtering at a certain minimum efficiency. Moreover, determining the effectiveness/efficiency of the filter elements in the gas turbine inlet system may be difficult because the results of the test filter elements can be masked with the results of non-test filter elements. Even further, it can be costly and/or inefficient to shut down the turbine inlet system to remove, replace, and test the test filter elements. Accordingly, it would be useful to provide a filter testing assembly, kit, and method in the form of a standardized shipping container that allows test filter elements to be tested in conditions that mimic and/or replicate the weather conditions of air flow in the turbine inlet system (e.g., wind speed, wind direction, temperature, humidity, etc.). It would also be useful for the filter testing assembly to be portable and to allow remote monitoring of the performance of the filter elements.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect, the present invention provides a portable filter testing assembly for testing filter elements. The testing assembly includes a first modular component including filter elements disposed within an interior of the first modular component. The first modular component defines a fluid flow inlet allowing fluid communication between the interior and an exterior of the first modular component. The testing assembly further includes a second modular component configured to be in fluid communication with the first modular component. The second modular component includes fluid flow drawing means for drawing fluid flow through the filter elements of the first modular component such that the fluid flow is filtered by the filter elements. Each of the first modular component and second modular component includes an external structure of a modular International Organization for Standardization (ISO) shipping container which provides a rectangular cuboid enclosure.

In accordance with another aspect, the present invention provides a kit of plural modular components for testing filter elements. The kit includes a first modular component for testing filter elements disposed with an interior of the first modular component. The first modular component defines a fluid flow inlet allowing fluid communication between the interior and an exterior of the first modular component such that the fluid flow is filtered by the filter elements. The kit further includes a second modular component to support the first modular component in a vertically stacked orientation to position the first modular component at an elevated position and/or a side-by-side orientation and to be in fluid communication with the first modular component. The second modular component includes fluid flow drawing means for drawing fluid flow through the filter elements of the first modular component. Each of the first modular component and second modular component has an external structure of a modular International Organization for Standardization (ISO) shipping container which provides a rectangular cuboid enclosure.

In accordance with another aspect, the present invention provides a method of using International Organization for Standardization (ISO) modular components for testing filter elements. The method includes the steps of providing a first modular component including a self-contained rectangular cuboid enclosure having the outside dimension of a standard, transportable ISO shipping container. The first modular component has a fluid flow inlet into the container for allowing fluid flow to enter and filter elements located within the first modular component for removing impurities from the fluid flow. The method further includes the step of providing a separately transportable second modular component including a self-contained rectangular cuboid enclosure having the outside dimension of a standard, transportable ISO shipping container. Each of the first modular component and the second modular component includes fluid flow openings. The method further includes the step of aligning and coupling the fluid flow openings of the first and second modular components and drawing fluid flow from an exterior to an interior of the first modular component and filtering the fluid flow by the filter elements in the first modular component. As such, filtered fluid flow is drawn into the second modular component.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematic, perspective illustration of an example portable filter testing assembly in accordance with one aspect of the invention;

FIG. 2 is a view similar to FIG. 1, but with the portable filter testing assembly partially torn open to show interior components, structures, and the like; and

FIG. 3 is schematic illustration of the portable filter testing assembly in communication with a remote location.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

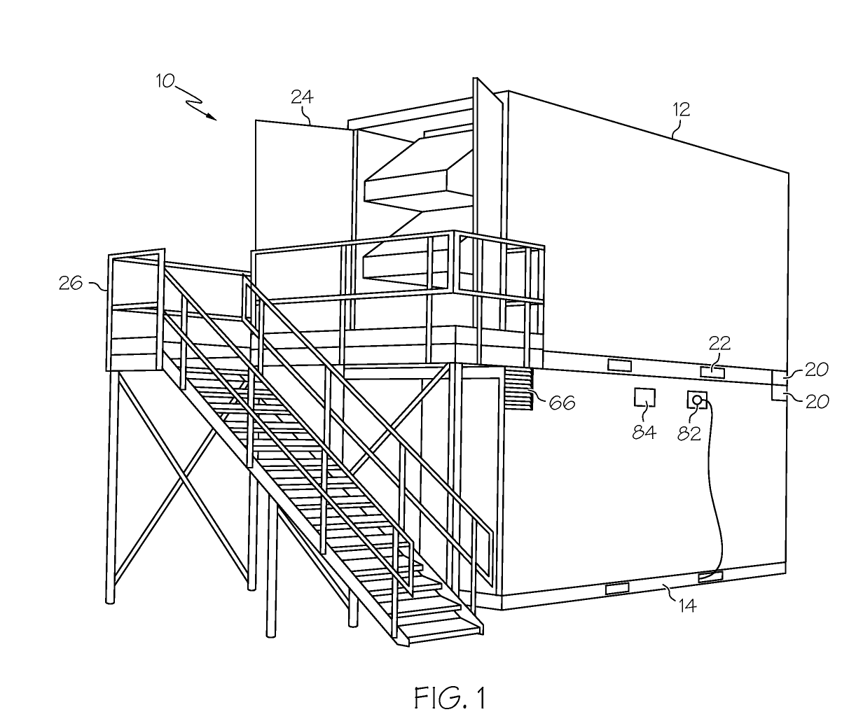

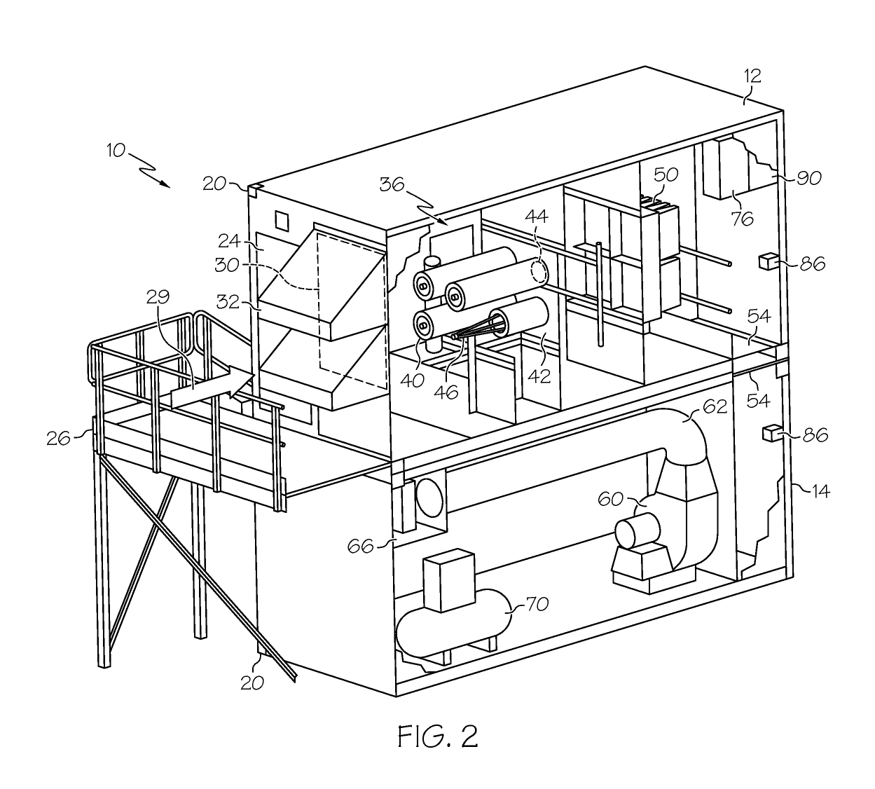

FIG. 1 illustrates a perspective view of an example portable filter testing assembly 10 in accordance with one aspect of the subject invention. The portable filter testing assembly 10 can include a first modular component 12 and a second modular component 14 arranged in a vertically stacked orientation. In brief synopsis, the first modular component 12 includes one or more filter elements (shown in FIG. 2) for test-filtering fluid flow passing through the portable filter testing assembly 10. The portable filter testing assembly 10 allows the filter elements to be tested, and such testing to be monitored as desired, prior to being incorporated in a use facility (i.e., permanent as opposed to temporary), such as a gas turbine inlet section. The portability allows the filter testing assembly 10 to perform the testing at the location of eventual use within the permanent facility located thereat. The vertically stacked orientation allows the portable filter testing assembly 10 to experience the same fluid input that the permanent facility experiences. Thus, there is a replication of eventual use conditions during the testing.

Turning to the example shown in FIG. 1, the first modular component 12 is shown as being positioned in a vertically stackable orientation with respect to the second modular component 14. Each of the first modular component 12 and second modular component 14 comprises a standardized shipping container. The shipping container can include one of a number of sizes designated by the International Organization for Standardization (ISO). The ISO shipping container may be known by other names, such as “intermodal container” or “intermodal freight shipping container.” There are five common standard ISO lengths: 20 ft. (6.1 m), 40 ft (12.2 m), 45 ft. (13.7 m), 48 ft. (14.6 m), and 53 ft (16.2 m). Typical width and height dimensions for the first modular component 12 and second modular component 14 can be 8 feet wide and 8 feet 6 inches high. However, it is to be appreciated that the modular components can encompass other ISO standard length containers and/or dimensions. In further examples, it is contemplated that other container sizes and shapes could be utilized in accordance with an aspect of the present invention. The shipping container can have the shape of a rectangular cuboid or rectangular box which has six sides with each side being a rectangle, with each face being effectively perpendicular to the adjacent faces, and with opposed faces being effectively the same size and parallel to each other. In other examples, the first modular component 12 is not limited to being positioned in the vertically stackable orientation with respect to the second modular component 14. Rather, the first modular component 12 can be positioned in a side-by-side orientation next to the second modular component 14, such that the first modular component 12 is laterally adjacent with the second modular component 14. In the side-by-side orientation, the first modular component 12 and second modular component 14 can be in fluid communication with each other in an identical manner as in the vertically stackable orientation described below.

Each of the first modular component 12 and second modular component 14 can include standard corner castings 20 at each corner of the shipping container. The corner castings 20 interact with the corner castings at the corners of other shipping containers or standard twist-locks found on transportation and moving equipment for shipping containers. The mating interaction between the corner castings 20 of first modular component 12 and second modular component 14 can allow for relatively rigid vertical contact between the containers when they are stacked vertically. These corner castings 20 may also be engaged by a transport vehicle (e.g., overhead travel lift) for moving and locating the container. It is to be appreciated that the corner castings 20 are somewhat generically depicted in FIG. 1, as the corner castings can include any number of sizes, shapes, and structures.

The first modular component 12 and second modular component 14 may also include other standard elements to allow for easier/more convenient shipping and transportation. For instance, in one example, the first modular component 12 and second modular component 14 include forklift pockets 22 for cooperative use with the forks of a loading and unloading device such as a forklift truck or a sidelifter. This construction method can allow the portable filter testing assembly 10 to take advantage of the standardized loading, shipping, connectivity and moving equipment infrastructure that is prevalent in many parts of the world. Similarly, since each of the modular components can be provided with the forklift pockets 22, the first modular component 12 and second modular component 14 can be separately movable and/or transportable from each other.

The modular components 12, 14 of the illustrated embodiment can each include a number of closures 24, such as doors, for operator access. For example, one or more closures 24 are provided so that an operator can enter the interior of the first modular component 12 (see FIG. 2) to operate interior components or to provide maintenance. Accordingly, in one example, an access assembly 26, such as a railing, ladder, or the like, is provided to allow a user to safely access closures that are located a distance above a ground surface.

The closures 24 can take various forms such as dual swinging closures (shown in FIG. 1), a single swinging door (shown in FIG. 2), rolling doors, or any other standard door that may be known in the art. The closures 24 can also be sealed to help ensure unwanted natural elements remain outside the modular components 12, 14 when the closures 24 are closed. The portable filter testing assembly 10 can thus be sealed intact and loaded with relative ease onto container ships, railroad cars, planes, and trucks. Enclosure within a standard (e.g., standard size, standard configuration, etc.) ISO shipping container enables modular components 12, 14 to be quickly deployed to remote job sites using a conventional transport vehicle, such as by rail, ship, or by a typical tractor trailer truck.

It is to be appreciated that the shown example has closures 24 for operator access located on the longitudinal ends of the modular components 12, 14. It is to be understood, however that the closures 24 may be positioned at different locations on the modular components 12, 14 and/or a different number (i.e., more or less) closures can be provided. For instance, in a further example, the closures 24 could be positioned on side walls. As such, the closures 24 shown and depicted in FIGS. 1 and 2 comprise merely one possible example of closures 24, as any number of sizes, shapes, and configurations are permitted for allowing a user to have access to an interior of the modular components 12, 14 and/or to allow for the entrance and exit of components.

Turning to the shown example of FIG. 2, a cut-away view of the portable filter testing assembly 10 is shown. It is to be appreciated that the example of FIG. 2 somewhat generically depicts an example of the portable filter testing assembly 10. Indeed, the exterior of the modular components 12, 14 in FIG. 2 can be slightly different than as shown in FIG. 1. For instance, the closures 24 may not be at the end of the first modular component 12 in FIG. 2 for illustrative purposes to show a clearer view of the end of the first modular component 12. In further examples, however, it is understood that the closures 24 may or may not be provided at the end of the first modular component 12. Rather, the closures 24 could be opened when the portable filter testing assembly 10 is in use, and can be closed when the portable filter testing assembly 10 is not in use and/or is being transported.

The first modular component 12 can include an aperture defining a fluid flow inlet 30. The fluid flow inlet 30 (shown only in phantom in FIG. 2 as the fluid flow inlet 30 is normally not visible in such a view) allows for fluid communication between an interior and an exterior of the first modular component 12. The fluid flow inlet 30 can have a size and shape to permit a required fluid flow from the exterior of the first modular component 12 into the interior of the first modular component 12. It is to be appreciated that the fluid flow inlet 30 shown in FIG. 2 depicts merely one possible example of a fluid flow inlet 30. As such, the size and shape of the fluid flow inlet 30 can be larger or smaller than as shown in FIG. 2, and could include a number of shapes, such as quadrilateral shapes, circular shapes, or the like.

The first modular component 12 can further include one or more hoods 32. The hoods 32 provide a shielding function to help protect the first modular component 12 from ingesting at least some materials and/or precipitation that may otherwise enter the first modular component 12. Examples of such materials that the hoods 32 can shield from ingestion can include, but are not limited to, leaves, branches, animals, dust, particulates, etc. The hoods 32 extend outwardly from the first modular component 12. Of course, the hoods 32 are not limited to the shown example, and can take on a number of different sizes, shapes, and configurations. Moreover, the hoods 32 can be designed to withstand some amount of impact force from the materials and/or precipitation. In further examples, the hoods 32 can be designed to match the size, shape, and/or performance of hoods in a gas turbine inlet system.

The first modular component 12 can further include a filter section 36. The filter section 36 is positioned within the interior of the first modular component 12 downstream from the fluid flow inlet 30. The filter section 36 is in fluid communication with the fluid flow inlet 30, such that the filter section 36 can receive the entering fluid flow from the fluid flow inlet 30. The filter section 36 can define a substantially open chamber such that air can enter and flow through the filter section 36.

The filter section 36 includes a plurality of filter elements for filtering the fluid flow. In particular, the filter elements can include a plurality of pulse filter elements 40. The pulse filter elements 40 are shown to extend substantially horizontally within the filter section 36 and are arranged in a vertically stacked orientation (i.e., one pulse filter element above another pulse filter element). However, in other examples, the pulse filter elements 40 can be arranged in a vertically staggered position, such that a pulse filter elements 40 is not positioned directly above or below an adjacent filter element. It is to be understood that the pulse filter elements 40 are only generically shown and depict merely one possible configuration. For example, the filter section 36 is shown to include four pulse filter elements, but in further examples, the filter section 36 can include a greater or fewer number of pulse filter elements 40 than in the shown example.

The pulse filter elements 40 can each comprise a generally cylindrical shape extending along a longitudinal axis. In one example, the pulse filter elements 40 can each include a cylindrically shaped section and a conically shaped section attached in an end to end configuration. Of course, it is to be appreciated that the pulse filter elements 40 can include a number of sizes and shapes, and need not be limited to the generally cylindrical shape depicted in FIG. 2. For example, the pulse filter elements 40 may include a single piece structure or a multiple piece structure. Even further, the pulse filter elements 40 may include a generally conical shape, a generally cylindrical shape, or a combination of the two. As such, the pulse filter elements 40 depict only one possible example of pulse filter element construction.

The pulse filter elements 40 can each include a filter media. The filter media can include a number of different materials that provide a filtering or filtration function. For instance, the filter media can include a variety of filtering materials that function to remove particulates from the fluid flow (e.g., air) that passes through the pulse filter elements 40. In one example, the pulse filter elements 40 can filter relatively high dust and/or high precipitation environments and can operate by rejecting dust and/or precipitation that accumulates on the filter with a pulse of compressed air. In colder environments, the pulse of compressed air can be directed and made sufficiently powerful to blow ice formed on the pulse filter elements 40. The filter media could further include a hydrophobic media. In one example, the filter media can include a polytetrafluoroethylene (PTFE) or expanded polytetrafluoroethylene (ePTFE). However, a variety of materials are contemplated that can function to limit and/or prevent the passage of liquid through the filter media.

The pulse filter elements 40 are each attached to a partition 42 that is positioned at a downstream location of the fluid flow inlet 30. The partition 42 includes a substantially vertically oriented wall that extends across the filter section 36 in a direction that is generally perpendicular to a fluid flow direction. The partition 42 can extend from the bottom wall towards the top wall and between opposing side walls of the partition 42. The partition 42 includes a generally non-porous structure, such that fluid flow is reduced and/or prevented from flowing through the partition 42. The partition 42 can further include one or more apertures 44 (shown only in phantom in FIG. 2 as the apertures are normally not visible in such a view) extending through the partition 42. The apertures 44 define openings through which the fluid flow can pass through the partition 42. As such, each of the pulse filter elements 40 can be attached to surround an aperture 44. The entering fluid flow can therefore pass through the pulse filter elements 40 prior to passing through the apertures 44.

The pulse filter elements 40 can further include a support structure 46. The support structure 46 is attached to the partition 42 and functions to attach the pulse filter elements 40 to the partition 42. The support structure 46 can extend along a longitudinal axis in a direction away from the partition 42. The support structure 46 can define a substantially rigid and/or non-flexible apparatus, such that the support structure 46 can support the weight of the pulse filter elements 40. The pulse filter elements 40 can be positioned to surround the support structure 46, such that the support structure 46 can extend within an interior of the pulse filter elements 40. One of the pulse filter elements 40 in FIG. 2 is shown in a partially detached/disassembled state so as to more clearly depict the support structure 46. Of course, it is to be understood that in operation, the pulse filter elements 40 are in a fully assembled state with each of the pulse filter elements 40 attached to and supported by a corresponding support structure 46. The pulse filter elements 40 can be readily attached and/or detached from the support structure 46. Accordingly, the pulse filter elements 40 can be removed from the support structure 46 and replaced, such as after being cleaned or by being replaced with a different pulse filter element. In further examples, the pulse filter elements 40 could be attached directly to the partition 42 without the support structure 46.

The filter section 36 further includes a plurality of static filter elements 50. The static filter elements 50 extend substantially horizontally within the filter section 36 and can be arranged downstream from the pulse filter elements 40. The static filter elements 50 can each include a gap, opening, or the like extending substantially vertically between adjacent static filter elements, such that water, liquid, particulates, dust, salt, or the like can drain away along a vertically downward direction. The static filter elements 50 can be designed to filter and remove fine dust and/or salt particulates or the like that may penetrate the pulse filter elements 40. The static filter elements 50 are somewhat generically depicted, as it is to be appreciated that the static filter elements 50 could include any number of constructions, some of which may be generally known.

The static filter elements 50 includes a filter media that can be formed from a number of different materials that provide a filtering or filtration function. For instance, the filter media can include a variety of filtering materials that function to remove particulates from air that pass through the static filter elements 50. In one example, the static filter elements 50 include a water tight filter that limits and/or prevent the passage of liquids that are in the fluid flow. In such an example, the static filter elements 50 include a polytetrafluoroethylene (PTFE), expanded polytetrafluoroethylene (ePTFE), or similar material that functions to limit and/or prevent the passage of liquid through the filter media. In further examples, the static filter elements 50 may include a fiberglass material or a similar filtering material and/or may include a coating or treatment made from a hydrophobic material, or a similar suitable water tight coating or treatment material. In one possible example, the static filter elements 50 have a higher efficiency filtering capacity than the pulse filter elements 40. In such an example, the static filter elements 50 will filter at least some of the particulate matter that manages to pass through the pulse filter elements 40. Of course, the static filter elements 50 are not limited to this example, and could include a wide range of filtering efficiencies.

It is to be appreciated that in further examples, the pulse filter elements 40 and static filter elements 50 are not limited to the positions shown in FIG. 2. Instead, the filter section 36 could include the pulse filter elements 40 positioned downstream from the static filter elements 50. In another example, the filter section 36 may not include one of the pulse filter elements 40 or the static filter elements 50. In such an example, the filter section 36 will only include pulse filter elements 40 or, in the alternative, will only include static filter elements 50. As such, an operator could selectively test only the pulse filter elements 40 or only the static filter elements 50 in the portable filter testing assembly 10.

Moving further downstream from the filter section 36, the first modular component 12 and second modular component 14 each include fluid flow openings 54. The fluid flow openings 54 can include an outlet fluid flow opening in the first modular component 12 through which fluid flow can exit and an inlet fluid flow opening in the second modular component 14 through which fluid flow can enter the second modular component 14. The fluid flow openings 54 are positioned downstream from the filter section 36, such that the fluid flow openings 54 receive filtered air that has been filtered by the pulse filter elements 40 and static filter elements 50.

The fluid flow openings 54 in each of the first modular component 12 and second modular component 14 can be positioned at corresponding locations adjacent each other such that the fluid flow openings 54 are in fluid communication. In one example, the fluid flow openings 54 are each positioned at an end of the portable filter testing assembly 10 opposite from the fluid flow inlet 30. One fluid flow opening is positioned at a lower surface adjacent an end of the first modular component 12. Another fluid flow opening 54 is positioned at an upper surface adjacent an end of the second modular component 14. As such, fluid flow will flow through the fluid flow openings 54 from the first modular component 12 to the second modular component 14. It is to be understood, however, that the fluid flow openings 54 can be positioned at nearly any location that is downstream from the filter section 36. In further examples, the fluid flow openings 54 can include closures, such as removable panels, or the like, allowing the fluid flow openings 54 to be readily opened (when in operation) or closed (when the modular components are being transported, for example).

The second modular component 14 further includes a fluid flow drawing means 60. The fluid flow drawing means 60 can be positioned in the second modular component 14 downstream from the filter section 36 and fluid flow openings 54. The fluid flow drawing means 60 is in fluid communication with the fluid flow openings 54. As such, the fluid flow drawing means 60 can function to draw fluid flow from an exterior and through the fluid flow inlet 30, through the filter section 36 and into the second modular component 14 through the fluid flow openings 54. In one example, the fluid flow drawing means 60 can include a fan or fan-like devices for creating air flow, though a number of objects are envisioned. In further examples, the fluid flow drawing means 60 includes compressors, pumps, or similar structures that function to draw air through the first modular component 12 and into an interior of the second modular component 14. The fluid flow drawing means 60 can be adjustable (i.e., to simulate various wind speeds and conditions), such that the fluid flow drawing means 60 can comprise a variable speed control fan. As such, the fluid flow drawing means 60 can be controlled to increase or decrease the fluid flow passing through the filter section 36.

It is to be appreciated that the fluid flow drawing means 60 is somewhat generically represented in FIG. 2, and could include a number of structures, some of which may be generally known, that perform a similar function. For instance, in a further example, the fluid flow drawing means 60 could include a fluid flow conduit (not shown), such as a duct, tube, pipe, or the like. The fluid flow conduit can be attached to the fluid flow drawings means 60 at one end and to the fluid flow openings 54 at an opposing end. As such, the fluid flow conduit can allow for fluid flow to pass from the fluid flow openings 54, through the conduit, and towards the fluid flow drawing means 60. It is to be understood, however, that a number of structures could be provided to place the fluid flow drawing means 60 in fluid communication with the fluid flow openings 54.

The second modular component 14 further includes an exit duct 62. The exit duct 62 is positioned in the second modular component 14 downstream from the fluid flow drawing means 60. The exit duct 62 can define a flow path along which filtered fluid can travel through. The exit duct 62 can be attached at an upstream end to the second modular component 14 and to an exit opening 66 at a downstream end. As such, the filtered fluid can exit the fluid flow drawing means 60, flow through the exit duct 62, and can exit the second modular component 14 through the exit opening 66.

The exit duct 62 can include a tube, conduit, or the like through which fluid can pass through. Of course, it is to be appreciated that the exit duct 62 and exit opening 66 can include a number of different sizes, locations, and orientations, and is not limited to the example shown in FIGS. 1 and 2. Rather, the exit duct 62 could extend a longer or shorter distance than as shown in FIG. 2, such that the exit opening 66 could be positioned closer to or farther from the fluid flow drawing means 60.

The second modular component 14 can further include a compressor 70. The compressor 70 can be positioned at a number of different locations within the second modular component 14. In one example, the compressor 70 can be positioned downstream from the fluid flow drawing means 60. The compressor 70 can be connected to a tank, solenoid valve, or the like (not shown) located in the filter section 36. The tank can include valves, such as fast acting valves, that can be selectively opened and closed. In one example, particulate materials can build up on an exterior surface of the pulse filter elements 40. As is generally known, the compressor 70 provides a pulse of air in a reversed direction with respect to the fluid flow to dislodge the particulate buildup. The valves are opened to allow the pulse of air to flow through the pulse filter elements 40.

The portable filter testing assembly 10 can still further include various elements to monitor the qualities and characteristics of fluid flow that passes through the filter section 36. For example, the portable filter testing assembly 10 can monitor various characteristics of the fluid flow with a weather monitoring device 76. It is to be appreciated that the weather monitoring device 76 is somewhat generically/schematically represented in FIG. 2, as it is understood that the weather monitoring device 76 can include any number of structures. For example, the weather monitoring device 76 monitors characteristics of the fluid flow 29 including, but not limited to, wind speed, wind direction, temperature, humidity, or the like. Of course, the weather monitoring device 76 is not limited to monitoring such characteristics, and could monitor other characteristics as well. The weather monitoring device 76 can include various structures/devices for monitoring weather, including, but not limited to, humidity monitors, pressure monitors, thermostats, and other similar devices. In further examples, the weather monitoring device 76, or a separate, additional weather monitoring device, could also monitor environmental conditions (temperature, pressure, humidity, wind speed, etc.) outside of the portable filter testing assembly 10 to supplement monitoring of the filter elements in the filter section 36.

The weather monitoring device 76 can be positioned at a number of locations within the portable filter testing assembly 10. For example, the weather monitoring device 76 could be positioned between the fluid flow inlet 30 and filter section 36. In another example, the weather monitoring device 76 could be positioned within the filter section 36, such as between the pulse filter elements 40 and static filter elements 50. Of course, it is to be appreciated that weather monitoring device 76 could be positioned at a variety of locations within either or both of the first modular component 12 and second modular component 14. As such, the weather monitoring device 76 can measure weather characteristics at multiple locations within the portable filter testing assembly 10. Along these lines, a plurality of weather monitoring devices 76 could be provided, such that weather characteristics could be simultaneously monitored at a number of locations within the portable filter testing assembly 10.

The portable filter testing assembly 10 includes various interfaces positioned on either or both of the first modular component 12 and second modular component 14 to operatively and releasably connect the portable filter testing assembly 10 to other systems. For example, an electrical connection 82 can be provided on one side of the portable filter testing assembly 10 for receiving electrical power. The electrical power is used to operate the electrical systems within the first modular component 12 and second modular component 14 including lighting fixtures (not shown), fluid flow drawing means 60, compressor 70, weather monitoring device 76, and/or any automatic controls. As another example, a monitoring connection 84 is provided on one side of one of the modular components for transmitting electrical signals from the interior of the portable filter testing assembly 10 to an exterior control unit. The electrical signals can originate at monitoring features within the portable filter testing assembly 10 such as humidity monitors, pressure monitors, thermostats, and other similar devices on either side of the filter section 36.

In one example, the portable filter testing assembly 10 can include structure used for unit location or identity purposes. For example, a Global Positioning System (GPS) unit 86 may be included in each of the first modular component 12 and second modular component 14. The GPS unit 86 is a device that uses the Global Positioning System to determine the precise location of the first modular component 12 and second modular component 14 to which it is attached and to record the position of the modular component at regular intervals. The recorded location data can be stored within a tracking unit, or it may be transmitted to a central location database, or internet-connected computer, using a cellular, radio, or satellite modem embedded in the unit. This allows the location of either or both of the first modular component 12 or second modular component 14 to be displayed against a map backdrop to locate the modular components and more easily plan global distribution and delivery of the modular components.

In another example, the first modular component 12 and second modular component 14 may each include Radio Frequency Identification (RFID) technology to create a tamper-evident shipping container. The RFID-enabled device can be embedded in the frame of the closures 24. Through a wireless network, the device can detect tampering with the first modular component 12 and second modular component 14. To enhance security, the door hinges can be located inside the first modular component 12 and second modular component 14 while having only the antenna of the RFID device visible from the outside. This feature allows the owners, transporters, and end users of the portable filter testing assembly 10 to be aware of any possible tampering during storage or shipping.

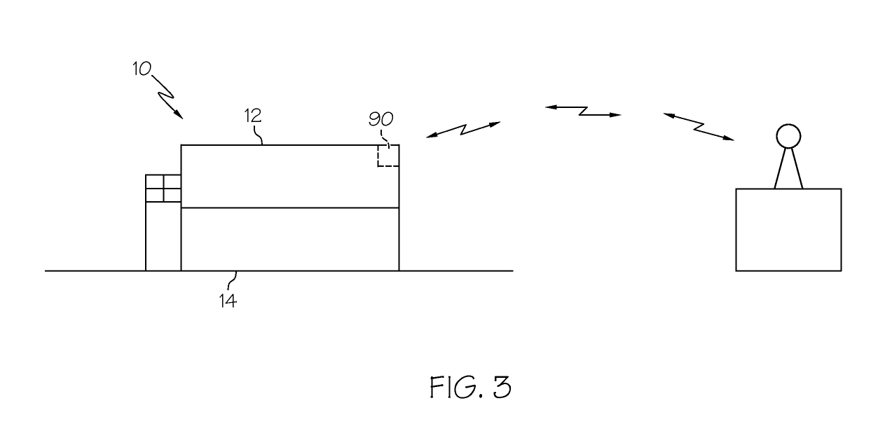

Referring now to FIG. 3, the portable filter testing assembly 10 can further include a system to allow for remote collection and/or measurement of information and data relating to the filter section 36. For instance, the portable filter testing assembly 10 can include a telemetry system 90. The telemetry system 90 can be located within either or both of the first modular component 12 and the second modular component 14. The telemetry system 90 can receive and/or transmit information pertaining to the portable filter testing assembly 10 to a remote location (shown somewhat generically/schematically in FIG. 3). The telemetry system 90 can allow for measurements, calculations, or the like pertaining to the filter section 36 to be made at a remote location. Still further, the telemetry system 90 can receive commands from the remote location to control various components within the portable filter testing assembly 10. The telemetry system 90 can include nearly any type of wireless data transfer mechanisms, including, but not limited to, radio waves, IP network transmissions, or the like. In other examples, the telemetry system 90 can include data transmission over media such as a telephone network, computer network, optical link (i.e., fiber optics, etc.), or other wired communications.

The telemetry system 90 can receive and transmit weather information pertaining to the filter section 36. For example, telemetry system 90 can be in operative association with the weather monitoring device 76, such that the telemetry system 90 can receive the weather characteristics (e.g., wind speed/direction, temperature, humidity, etc.) from the weather monitoring device 76. The telemetry system 90 can then transmit these weather characteristics of the fluid flow 29 to a remote location, thus allowing for remote monitoring of the weather characteristics at the portable filter testing assembly 10.

In another example, the telemetry system 90 can be in communication with one or more sensors. The sensors can be associated with the filter section 36 and can measure the performance of the either or both of the pulse filter elements 40 and static filter elements 50. The sensors can measure information including filtration efficiency, and the like. The telemetry system 90 can also transmit this filtration efficiency information to the remote location, thus allowing for the portable filter testing assembly 10 to be monitored at locations nearly anywhere in the world.

The telemetry system 90 can further be in communication with one or more of the components in the portable filter testing assembly 10. For example, the telemetry system 90 can be in communication with the fluid flow drawing means 60, compressor 70, etc. As such, in one example, the telemetry system 90 can receive information and/or commands from the remote location. The information/commands are received by the telemetry system 90 and used to control the components in the portable filter testing assembly 10. For example, a user at a remote location can alter the performance of the fluid flow drawing means 60 and/or activate/deactivate the compressor 70 based, at least in part, on the weather characteristics. Accordingly, the portable filter testing assembly 10 can both be monitored and controlled from a remote location with the telemetry system 90.

The method and operation of the portable filter testing assembly 10 can now be explained. The portable filter testing assembly 10 can initially be placed in close proximity to the gas turbine inlet section for which the portable filter testing assembly 10 is testing filter elements. For example, the first modular component 12 and second modular component 14 can be moved/transported by means of a forklift truck, sidelifter, or the like. The first modular component 12 is arranged in a vertically stacked orientation (or, alternatively, in a side-by-side orientation) and can rest on top of (or next to) the second modular component 14. As such, in the vertically stacked orientation, the first modular component 12 is positioned a distance above ground, such that the inlet opening of the first modular component 12 is at a similar height as an inlet opening for the gas turbine inlet section. Such subjects the fluid flow inlet 30 of the filter testing assembly 10 to the same propensity, or lack of propensity, to ingest matter within the fluid flow that is to be filtered out. Moreover, the portable filter testing assembly 10 can be positioned next to the gas turbine inlet section, such that the weather characteristics (e.g., wind speed/direction, temperature, humidity, etc.) in the portable filter testing assembly 10 can be similar to the gas turbine inlet section.

Once in place, the fluid flow openings 54 can be aligned while the first modular component 12 and second modular component 14 can be coupled together. The portable filter testing assembly 10 can receive fluid flow 29 through the fluid flow inlet 30. Initially, the fluid flow drawing means 60 is activated and can draw fluid flow from an exterior and through the fluid flow inlet 30. The hoods 32 helps shield the first modular component 12 from ingesting foreign articles, such as leaves, branches, animals, etc. Once inside the first modular component 12, the fluid flow 29 enters the filter section 36. In the filter section 36, the fluid flow 29 is initially filtered by the pulse filter elements 40. The fluid flow 29 can flow through the pulse filter elements 40 and then through the apertures 44. After flowing through the apertures 44, the fluid flow 29 is filtered by the static filter elements 50 before exiting the first modular component 12 and entering the second modular component 14 through the fluid flow openings 54. The filtered fluid flow can then flow through the exit duct 62 and exit the second modular component 14 through the exit opening 66.

The fluid flow 29 can be monitored by the weather monitoring device 76. For example, the weather monitoring device 76 can detect characteristics such as wind speed/direction, temperature, humidity, etc. In addition or in the alternative, sensors can be provided for monitoring the characteristics, such as performance, of either or both of the pulse filter elements 40 and static filter elements 50. In one example, the sensors can monitor the filtration efficiency. Accordingly, both the weather characteristics of the fluid flow and the filter characteristics can be transmitted by means of the telemetry system 90 to a remote location (see FIG. 3). As such, a user at the remote location can monitor the portable filter testing assembly 10 and, based on the characteristics, can provide commands to the portable filter testing assembly 10, such as increasing/decreasing the speed of the fluid flow drawing means 60 or providing a pulse of compressed air from the compressor 70 to the pulse filter elements 40.

After a certain predetermined period of time has passed, a user may enter the portable filter testing assembly 10, such as through the closures 24, to inspect, repair, and/or replace the pulse filter elements 40 and static filter elements 50. Accordingly, the portable filter testing assembly 10 can allow for the pulse filter elements 40 and static filter elements 50 to be tested. In particular, the pulse filter elements 40 and static filter elements 50 can be safely tested in an environment that substantially mimics the gas turbine inlet system by having similar weather characteristics. As such, the portable filter testing assembly 10 allows the filter elements to be tested prior to being used in the gas turbine inlet system.

The portable filter testing assembly 10 may conveniently be packaged in the form of a kit that includes a number of components providing increased convenience, flexibility, and adaptability to operators in the field. For example, the kit may include the first modular component 12 with the pulse filter elements 40 and static filter elements 50 disposed within an interior. The kit may further include the second modular component 14 with the fluid flow drawing means 60 disposed within an interior. All of which can be conveniently packaged in a way that is easy to transport with the use of standard handling equipment in many parts of the world.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A portable filter testing assembly for testing filter elements, the testing assembly including:
a first modular component including filter elements disposed within an interior of the first modular component, the first modular component defining a fluid flow inlet allowing fluid communication between the interior and an exterior of the first modular component; and
a second modular component configured to be in fluid communication with the first modular component, the second modular component including fluid flow drawing means for drawing fluid flow through the filter elements of the first modular component such that the fluid flow is filtered by the filter elements;
wherein each of the first modular component and second modular component includes an external structure of a modular International Organization for Standardization (ISO) shipping container which provides a rectangular cuboid enclosure.

2. The portable filter testing assembly for testing filter elements of claim 1, wherein the fluid is air.

3. The portable filter testing assembly for testing filter elements of claim 1, wherein the filter elements include a plurality of pulse filter elements.

4. The portable filter testing assembly for testing filter elements of claim 1, wherein the filter elements include a plurality of static filter elements positioned downstream from a plurality of pulse filter elements.

5. The portable filter testing assembly for testing filter elements of claim 1, wherein the first modular component is removably attached to the second modular component such that the first modular component is positioned vertically on top of the second modular component.

6. The portable filter testing assembly for testing filter elements of claim 5, wherein each of the first modular component and second modular component include a fluid flow opening, the fluid flow openings being positioned adjacent each other when the first modular component is attached to the second modular component such that fluid flow is configured to exit the first modular component and enter the second modular component by passing through the fluid flow openings.

7. The portable filter testing assembly for testing filter elements of claim 1, wherein the first modular component is detachable from the second modular component and separately movable from the second modular component.

8. The portable filter testing assembly for testing filter elements of claim 1, further including a weather monitoring device for monitoring weather characteristics within the first modular component.

9. The portable filter testing assembly for testing filter elements of claim 8, wherein the weather monitoring device is configured to monitor wind speed and wind direction of the fluid flow.

10. The portable filter testing assembly for testing filter elements of claim 8, wherein the weather monitoring device is configured to monitor the temperature and humidity of the fluid flow.

11. The portable filter testing assembly for testing filter elements of claim 3, wherein at least one of the first modular component and the second modular component includes a compressor, the compressor configured to provide a pulse of air in a reversed direction with respect to the fluid flow to the pulse filter elements.

12. The portable filter testing assembly for testing filter elements of claim 1, wherein at least one of the first modular component and the second modular component includes a GPS unit for receiving and transmitting global positioning data.

13. The portable filter testing assembly for testing filter elements of claim 1, wherein at least one of the first modular component and the second modular component includes a telemetry system to receive information and to transmit information about the filter elements to a remote location.

14. A kit of plural modular components for testing filter elements, the kit including:
a first modular component for testing filter elements disposed with an interior of the first modular component, the first modular component defining a fluid flow inlet allowing fluid communication between the interior and an exterior of the first modular component, wherein the fluid flow is filtered by the filter elements; and
a second modular component to support the first modular component in a vertically stacked orientation to position the first modular component at an elevated position and/or a side-by-side orientation and to be in fluid communication with the first modular component, the second modular component including fluid flow drawing means for drawing fluid flow through the filter elements of the first modular component;
wherein each of the first modular component and second modular component has an external structure of a modular International Organization for Standardization (ISO) shipping container which provides a rectangular cuboid enclosure.

15. The kit of components according to claim 14, wherein the filter elements include a plurality of pulse filter elements.

16. The kit of components according to claim 14, wherein the filter elements include a plurality of static filter elements positioned downstream from a plurality of pulse filter elements.

17. A method of using International Organization for Standardization (ISO) modular components for testing filter elements, the method including the steps of:
providing a first modular component including a self-contained rectangular cuboid enclosure having the outside dimension of a standard, transportable ISO shipping container, the first modular component having a fluid flow inlet into the container for allowing fluid flow to enter and filter elements located within the first modular component for removing impurities from the fluid flow;
providing a separately transportable second modular component including a self-contained rectangular cuboid enclosure having the outside dimension of a standard, transportable ISO shipping container, each of the first modular component and the second modular component including fluid flow openings;
aligning and coupling the fluid flow openings of the first and second modular components;
drawing fluid flow from an exterior to an interior of the first modular component and filtering the fluid flow by the filter elements in the first modular component, wherein filtered fluid flow is drawn into the second modular component.

18. The method of claim 17, further comprising the step of transmitting information about the filter elements to a remote location.

19. The method of claim 17, further comprising the step of monitoring weather characteristics of the fluid flow.

20. The method of claim 17, further comprising the step of stacking the first modular component vertically on top of the second modular component to position the first modular component at an elevated position.
